(19) United States
(12) Patent Application Publication
(10) Pub. No.: US 2009/0037496 A1
(43) Pub. Date: Feb. 5, 2009

(54) Diagnostic Virtual Appliance

(76) Inventors: Benedict T. Chong, San Jose, CA (US); Phillp Sheu, San Jose, CA (US); Thomas Deng, Cupertino, CA (US); Eric Tzu-Chun Chou, Taipel (TW); Xun Fang, Livermore, CA (US)

Correspondence Address: GLENN PATENT GROUP, 3475 EDISON WAY, SUITE L, MENLO PARK, CA, 94025, US

(21) Appl. No.: 12/184,378

(22) Filed: Aug. 1, 2008

Related U.S. Application Data
(60) Provisional application No. 60/953,276, filed on Aug. 1, 2007.

(51) Int. Cl. G06F 21/00; G06F 11/26; G06F 17/30; G06F 9/445

(52) U.S. Cl. 707/204; 714/27; 726/24; 713/2; 714/E11.159; 707/E17.01

(57) ABSTRACT

A virtual appliance environment (VAE) consists of components residing on a computer BIOS ROM and also on a mass storage device. The VAE includes a virtual appliance (VA) for diagnosing malfunctioning hardware or software. The VA for diagnosing malfunctions tests the hardware and/or software resident in the computer and transmits the results of the test to a server, which diagnoses the problem and transmits instructions to the VAE for saving the data, determining whether the computer is under warranty, and providing shipping information to a user. The VAE can also download a VA for scanning viruses. The VAE transmits the results of the virus scan to the server, which determines the type of virus infecting the computer and transmits instructions to the virtual appliance for downloading the appropriate VA for removing the virus. The VAE can save the data to another source, remove the virus, and restore the data or simply remove the virus.

### CROSS REFERENCE TO RELATED APPLICATIONS

This patent application claims the benefit of U.S. provisional patent application Ser. No. 60/953,276, Diagnostic Virtual Appliance, filed 1 Aug. 2007, the entirety of which is hereby incorporated by this reference thereto.

### BACKGROUND OF THE INVENTION

1. Technical Field

This invention relates generally to the field of personal computers. More specifically, this invention relates to tools for remote diagnostic and support for personal computers.

2. Description of the Related Art

Computers are essential for running businesses and for personal use. When a computer experiences a hardware or software problem, the user lacks the tools for diagnosing the problem. Standard computers frequently provide diagnostic tools for scanning isolated pieces of hardware, such as a printer, but running a diagnostic while the operating system (OS) is fully loaded can interfere with the accuracy of the test.

In addition, if the OS is running, the accuracy of diagnostic tests may be affected. Furthermore, some software problems may prevent the OS from functioning. When the OS cannot run, software diagnostics and repair must be performed from a different environment.

In addition, when the computer becomes infected with a virus, the results can be devastating. Experts estimate that each year viruses and spyware cost businesses about four billion a year in repair or replacement of infected computers.

Viruses can take the form of software that piggybacks onto a larger program, such as word-processing software, an attachment to an email, a computer program claiming to perform a legitimate function (Trojan horse), and software that uses computer networks and security holes to replicate itself (Worms).

A user can use anti-virus software to run a virus scan, locate the offending program, and try to remove it. The disadvantage of this method, however, is that continued use of an infected computer can cause additional harm. Furthermore, anti-virus software is only useful if the virus definitions are up-to-date. Many viruses contain code for preventing virus software from performing subsequent updates, thereby preventing the computer from having any means of deleting the virus.

Another alternative is to perform a system restore where the system files, registry keys, and installed programs are rolled back to a period of time where the system was uninfected. This method has multiple complications including loss of data and programs that contain a mix of old and new program files and folders. Furthermore, some viruses can corrupt the restore files, thereby preventing the system restore from successfully removing the virus.

If the virus presents a serious threat to the computer, another method for fixing the problem is to reinstall part or all of the OS. The disadvantage of this method, however, is that data can be lost, the process is time consuming, and the process can require reinstalling software in addition to reinstalling the OS.

It would be advantageous to provide a remote diagnostics and support feature that does not require loading the OS.

### SUMMARY OF THE INVENTION

A virtual appliance environment (VAE) is an embedded OS, i.e. secondary OS that is included in the system boot ROM or on other storage media of a personal computer. The VAE coordinates the download and running of a virtual appliance (VA). A VA is a self-contained software application and may also include an operating system. Different VAs can be created for various diagnostic purposes. For example, a VA can scan for hardware faults. Another VA can scan for file system errors. Yet another VA can scan for registry errors or faults in the default OS. Yet another can scan for and remove viruses. VAs can also repair the faults discovered.

In one embodiment, the VA tests the hardware or software and transmits data to a server, which provides the VAE with instructions for downloading another VA to save the data, perform the repair, or determine whether the computer is under warranty and provide shipping information to a user. In the event of a hardware or software error, the data sent from the VA can be used by the server to arrange for a shipping box to be sent to the user so that the user can send the computer to the manufacturer for repair.

In another embodiment, the VAE can download a VA that scans the computer for viruses. The VAE transmits the data to a server, which determines the type of virus infecting the computer and transmits instructions for downloading a VA that removes or isolates the virus. The VAE can download a VA that saves the data to another source, removes the virus, and restores the data.

### BRIEF DESCRIPTION OF THE DRAWINGS

FIG. 1 is a block diagram that illustrates a system for implementing a VAE according to one embodiment of the invention;

FIG. 2 is a block diagram that illustrates one embodiment of a system for implementing a VAE;

FIG. 3 is a flowchart that illustrates the steps of using a diagnostic VAE according to one embodiment of the invention;

FIG. 4 is an example of a display screen that illustrates the progress of a download for the diagnostic tools according to one embodiment of the invention;

FIG. 5 is an example of a display screen that illustrates the progress of a diagnostic scan of a computer according to one embodiment of the invention;

FIG. 6 is an example of a display screen that illustrates the results of a diagnostic scan that did not detect any hardware errors according to one embodiment of the invention;

FIG. 7 is an example of a display that illustrates that the diagnostic tool can be downloaded according to one embodiment of the invention;

FIG. 8 is an example of a display that illustrates the progress of the download of the backup tool with a progress bar according to one embodiment of the invention;

FIG. 9 is an example of a display that illustrates the progress of the backup according to one embodiment of the invention;

FIG. 10 is a flowchart that illustrates the steps of using a VA for removing viruses according to one embodiment of the invention;

FIG. 11 is an example of the display screen that illustrates the option of selecting for download a VA for scanning viruses according to one embodiment of the invention;

FIG. 12 is an example of a display screen that illustrates the progress of a download for the virus scanner according to one embodiment of the invention;

FIG. 13 is an example of a display screen that illustrates the progress of the virus scan according to one embodiment of the invention;

FIG. 14 is an example of a display that illustrates the presence of a virus according to one embodiment of the invention; and

FIG. 15 is an example of a display that illustrates the successful removal of a virus according to one embodiment of the invention.

### DETAILED DESCRIPTION OF THE INVENTION

The invention comprises a method and/or an apparatus that are configured as a virtual appliance (VA) for diagnosing malfunctioning hardware or software in a computer. In another embodiment, the invention comprises a VA configured to scan the client and remove viruses. In another embodiment, the VA performs intelligent system configuration.

In one embodiment of the invention, a VAE is included in the system boot ROM of a personal computer. The VAE quickly boots up and installs the necessary drivers for network access and a graphics display. The boot process takes about three seconds to have an instant-on appearance. The VAE then immediately accesses the network to retrieve a VA and execute it, or it may retrieve a VA from the BIOS ROM or other storage media. The different variations for implementing a VA are described in U.S. patent application Ser. No. 11/772,700, filed Jul. 2, 2007 (Attorney Docket No. DEVM0004), the contents of which are herein incorporated in their entirety by this reference.

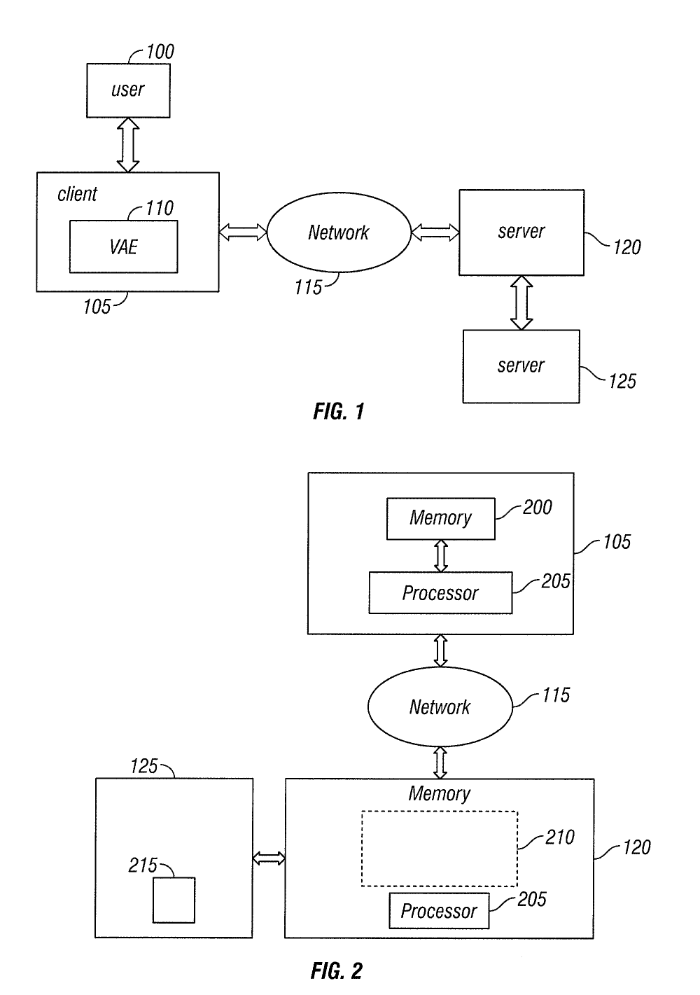

FIG. 1 is a block diagram that illustrates a system for implementing a VAE 110. A user 100 uses a client 105, e.g. a computing platform configured to act as a client device such as a computer, a digital media player, a personal digital assistant, or a cellular telephone, containing a VAE 110. When the client 105 malfunctions, the user 100 activates the VAE 110, which communicates with a server 120, e.g. a computing platform configured to act as a server, over the network 115, e.g. a local area network, a home network, the Internet.

In one embodiment, the network 115 can be implemented via wireless and/or wired solutions. The server 120 may contact another server 125 to obtain additional information, e.g. whether the computer has an active warranty. The servers 120 and 125 are illustrated as being two interconnected computing platforms that act in concert, but in other instances the system could have a single computing platform or more than two computing platforms acting in concert.

FIG. 2 is a simplified diagram illustrating an exemplary architecture in which the system for using a VAE 110 is implemented. The exemplary architecture includes a client 105, a server 120 device, and a network 115 connecting the client 105 to the server 120. The client 105 is configured to include a computer-readable medium 200, such as random access memory or magnetic or optical media, coupled to an electronic processor 205. The processor 205 executes program instructions stored in the computer-readable medium 200.

The server 120 device includes a processor 205 coupled to a computer-readable medium 210. In one embodiment, the server 120 device is coupled to one or more additional external or internal devices or servers 125, such as, without limitation, a secondary data storage element, such as a database 215 for storing the warranty information.

The server 120 includes instructions for controlling a VAE 110. In one embodiment, the client 105 contains, in part, the customized application. Additionally, the client 105 and the server 120 are configured to receive and transmit electronic messages for use with the customized application.

One or more user applications are stored in memories 200, in memory 210, or a single user application is stored in part in one memory 200 and in part in memory 210.

Diagnostic Tool

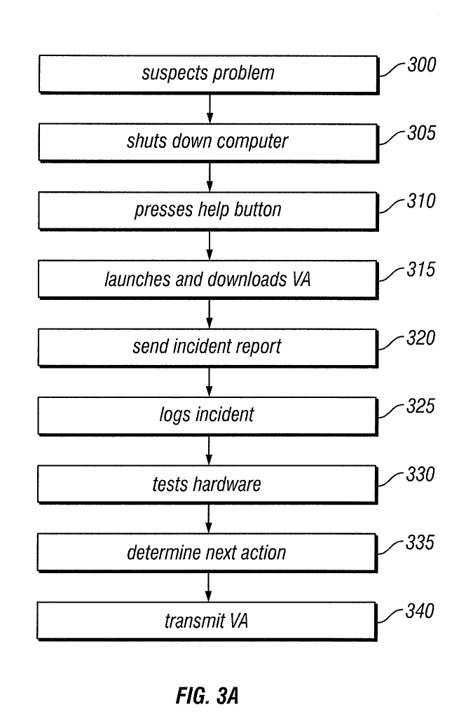

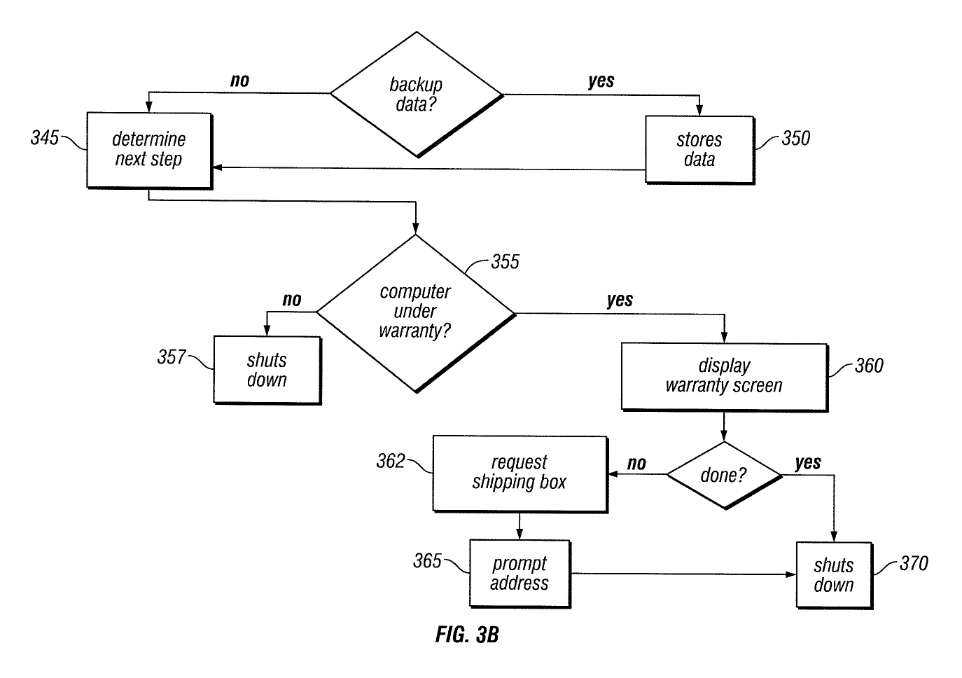

FIG. 3 is a flowchart that illustrates the steps of using a diagnostic VAE 110 for detecting malfunctioning hardware and software. When a user 100 suspects 300 that the computer is experiencing a problem, the user 100 shuts 305 down the computer and presses 310 a “help” button. The button can be a hotkey located on a desktop computer or a laptop, examples of which will be apparent to one of ordinary skill in the relevant art.

In another embodiment, the VAE 110 can be activated during the booting process. The VAE 110 displays a problem screen with several options for the type of problem that the user 100 is experiencing, e.g. Microsoft Windows does not boot, Application error, etc.

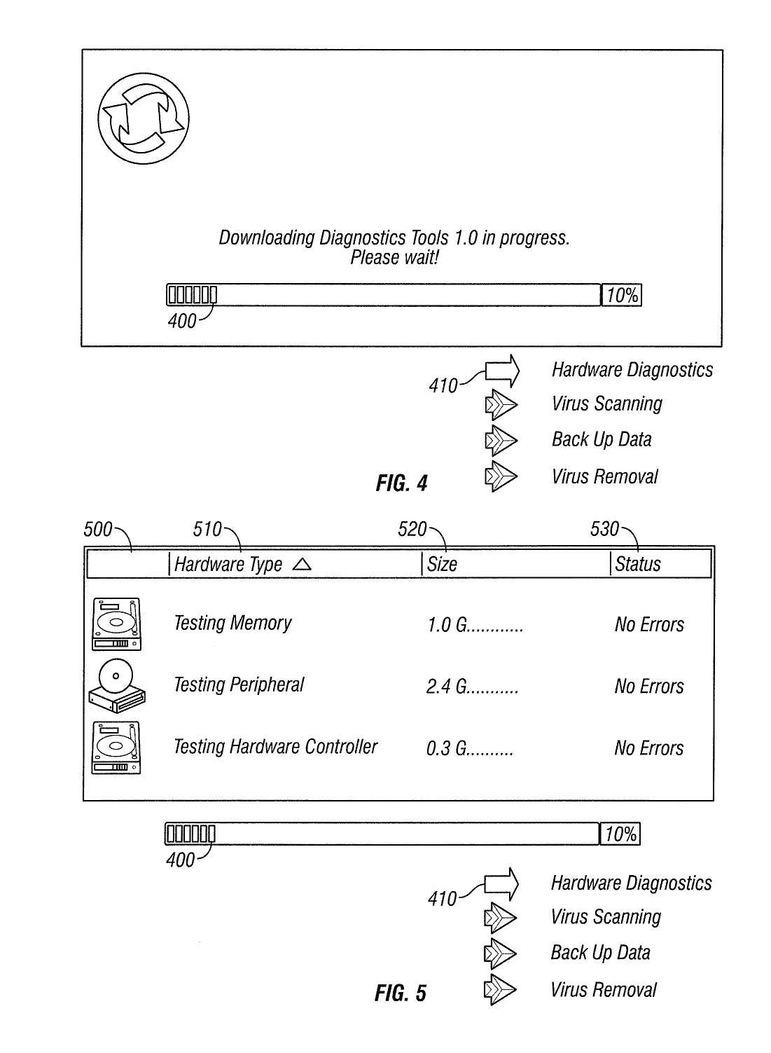

The VAE 110 launches 315 and downloads a diagnostic tool VA for diagnosing the hardware or software error. While the VA downloads, the VAE 110 displays a screen to the user 100 that shows the progress of the download. FIG. 4 is an example of a display screen that illustrates the progress of a download of diagnostic tools for diagnosing a hardware error. The display screen indicates the progress of the download in the form of a progress bar 400. The display also indicates that the VAE 110 is in the hardware diagnostics stage through use of a dark-gray shaded arrow 410. The VAE 110 sends 320 an incident report to the server 120, which logs 325 the incident.

The diagnostic tool tests 330 the hardware or software on the computer. While the diagnostic tool runs, the VAE 110 displays a screen to the user 100. FIG. 5 is an example of a display screen that illustrates the progress of the diagnostic tests. The screen includes a progress bar 400, an arrow 410 showing that the VAE is still in the hardware diagnostics stage, icons 500 of the type of devices being tested, the name of the hardware type 510, e.g. memory, peripheral, hardware controller, the size 520 of the hardware type, e.g. 1.0 G, and the status 530 of the test, e.g. no errors.

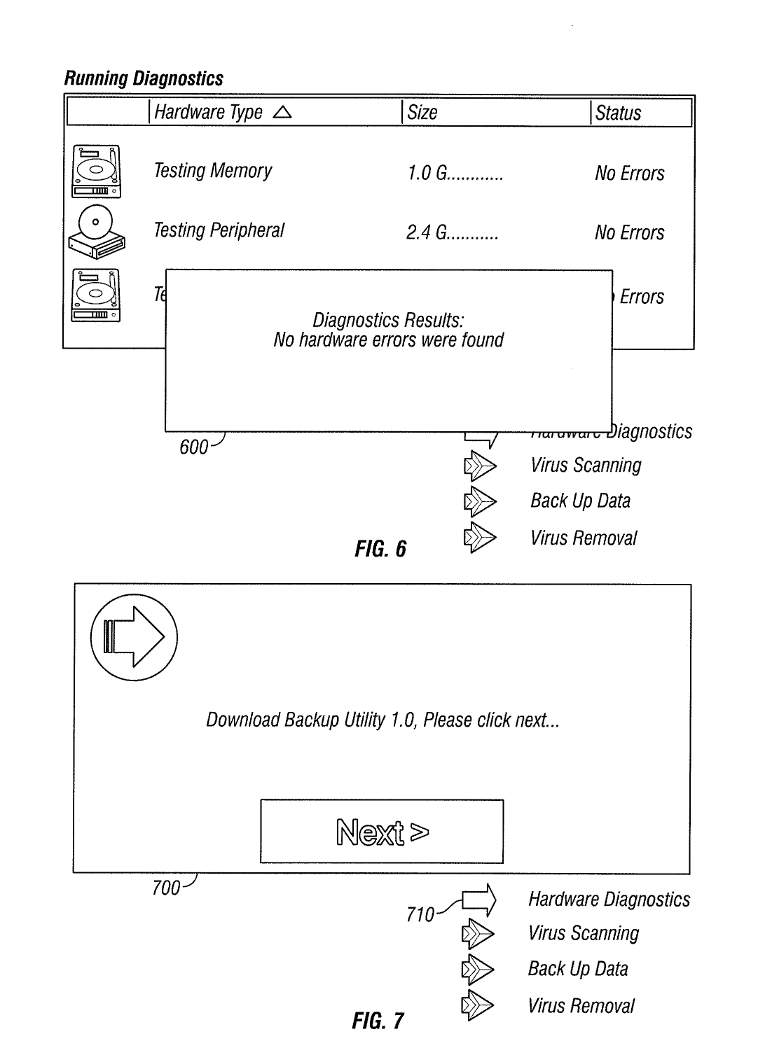

Once the VAE 110 completes the diagnostic test, it displays the results of the test. FIG. 6 is an example that illustrates a diagnostic test where no hardware errors were detected. The results are displayed in a window 600 laid over the diagnostic test details.

The VAE 110 transmits the results to the server 120, which determines 335 the next action. If the diagnostic tool does not detect any errors, the server 120 instructs the VAE 110 to provide the user 100 with the option of downloading, for example, a VA for scanning viruses as discussed below. In another embodiment, the VAE can download another diagnostic tool, depending on the diagnostics process used. For example, the VAE 110 can download a diagnostic tool for checking the default OS or file system integrity. In another embodiment, the server 120 instructs the VAE 110 to ask the user 100 whether it should download a VA for performing a backup, where data can be saved in an alternate location in case of system failure.

If the diagnostic tool does detect hardware or software errors, the VAE 110 polls the server 120 for information about downloading a VA to address the error. Based on the results of the diagnostic test, the server 120 transmits 340 a name and other information, e.g. type of utility, the internet protocol for the download server, etc., relating to the appropriate VA for performing additional tests, diagnostics, or to perform a repair process.

Due to computer network limitations, the server cannot independently transmit, i.e. push the VA to the client 105. Therefore, the VAE 110 must request that the server provide instructions about which VA to download. If the server does not respond or responds with a “don't know”, the VAE 110 will re-ask after a certain amount of time.

The VAE will provide the user 100 with the option of selecting a VA for download for backing up data. FIG. 7 is an example of a display 700 that provides the user 100 with the option of downloading a VA called Backup Utility. The hardware diagnostics stage arrow 710 is a shade of light-gray, indicating that the hardware diagnostics stage is complete.

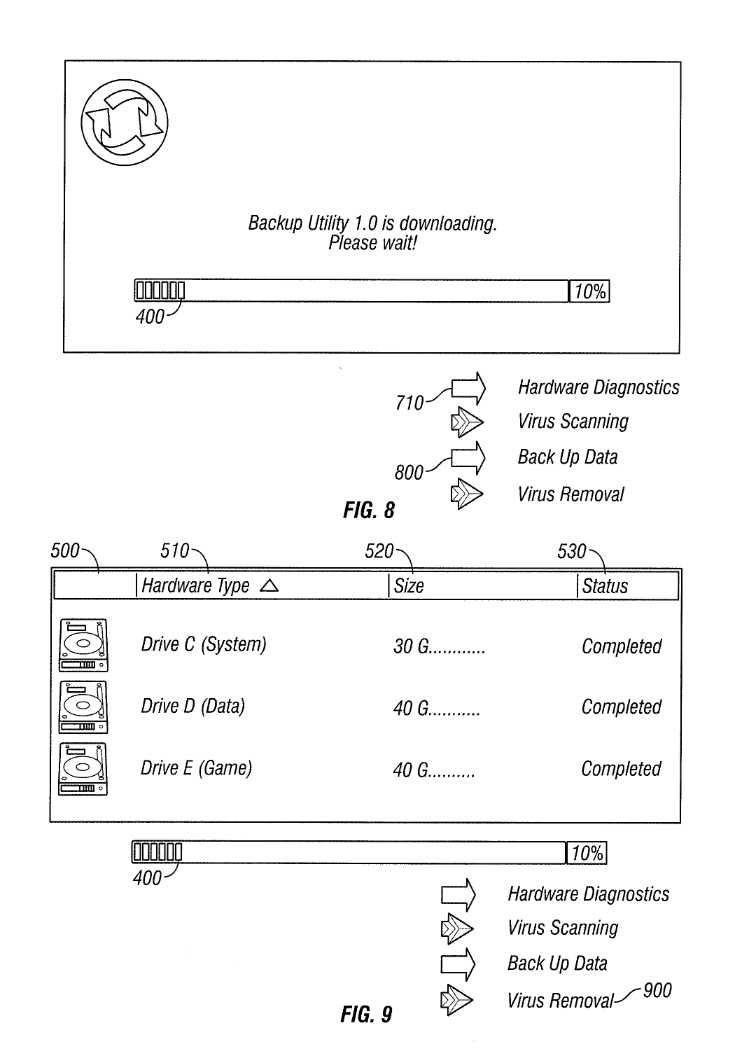

If the user 100 indicates that he wants the VA to be downloaded, or if the VA is automatically downloaded, the VAE 110 can display the progress of the download. FIG. 8 is an example of a display that illustrates the progress of the download of the backup tool with a progress bar 400. The hardware diagnostic stage arrow 710 is a shade of light-gray, indicating that the hardware diagnostics stage is complete. The backup data stage arrow 800 is a shade of dark-gray, indicating that the virtual application 110 is currently in that stage.

The VAE 110 asks the user 100 whether it should perform a backup. If the user 100 answers no, the VAE 110 polls the server to determine 345 the next step. In one embodiment, the server 120 instructs the VAE 110 to poll another server 125 to determine whether the computer is covered by a warranty. In another embodiment, the VAE 110 finds the warranty information on the computer or asks the user 100 for warranty information.

If the user 100 wants to backup data, the VA stores 350 the data using either online or local storage. While the backup tool saves the data, the VAE 110 provides the user with status updates. FIG. 9 is an example of a display that illustrates the progress of the backup. The display can be similar to the display for the diagnostic scan. The display can include a progress bar 400, icons 500 of the type of devices being tested, the name of the hardware type 510, e.g. Drive C, Drive D, Drive E, the size 520 of the hardware type, e.g. 30 G, the status 530 of the backup, e.g. completed. In one embodiment of the invention, the virus removal stage letters 900 are grayed-out because the diagnostics tool determined that the computer malfunction stems from a hardware error and not a virus.

Once the VA backs up the data, the server 120 determines 345 the next step. In one embodiment, the VAE 110 downloads a VA for fixing the error. In another embodiment, the server 120 instructs the VAE 110 to poll another server 125 to determine whether the computer is covered by a warranty. The VAE 110 can find the warranty information on the computer or ask the user 100 for warranty information. If the computer is not under warranty or the warranty is no longer valid, the VAE 110 shuts down 357 the computer. In one embodiment, the VAE 110 provides the user 100 with the results of the hardware and software scan so that the user 100 can bring the results to a computer technician to aid in fixing the computer.

If the VAE 110 determines that the warranty is still active, the VAE 110 provides the user 100 with return material authorization (RMA). For example, the VAE 110 displays 360 a screen stating: “Your computer is still under warranty. Your RMA# is 01234123. Please pack your computer in its original packaging and ship it to: Service & Repair Department, 123 OEM Way, San Jose, Calif. 95134, USA. The user 100 has the option of either indicating that she is done or requesting a shipping box. If the user 100 indicates that she is done, the VAE 110 automatically shuts down 370 the computer.

If the user 100 requests 362 a shipping box, the VAE 110 prompts 365 the user 100 for an address. Once the user 100 enters the address, the VAE 110 displays a screen stating “The shipping box will be sent to: <the address you entered>. You will receive it within 2 business days.” The VAE 110 then shuts down 370 the computer.

In another embodiment of the invention, the VAE 110 can scan for viruses while the default OS is inactive. The virus scan can occur if no hardware or software errors are found during the diagnostic scan, the virus scan can occur in addition to the diagnostic scan, or the virus scan can be a separate application altogether. A person of ordinary skill in the relevant art understands the advantages and disadvantages of each embodiment of the invention. The virus scan is described in more detail below

Virus Scenario

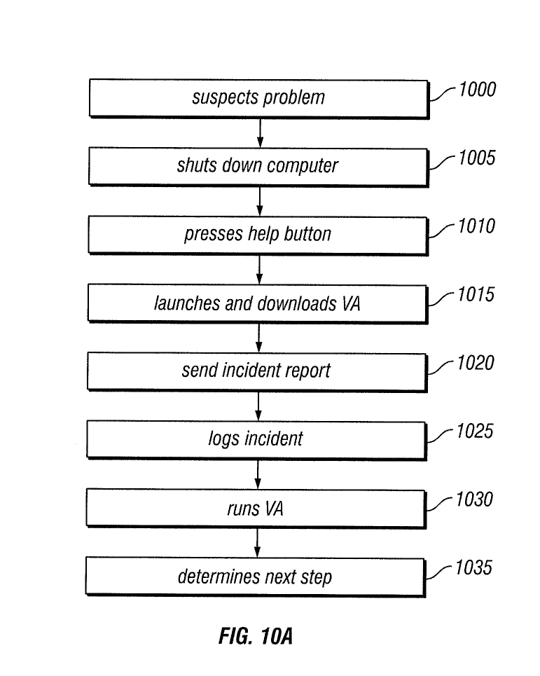

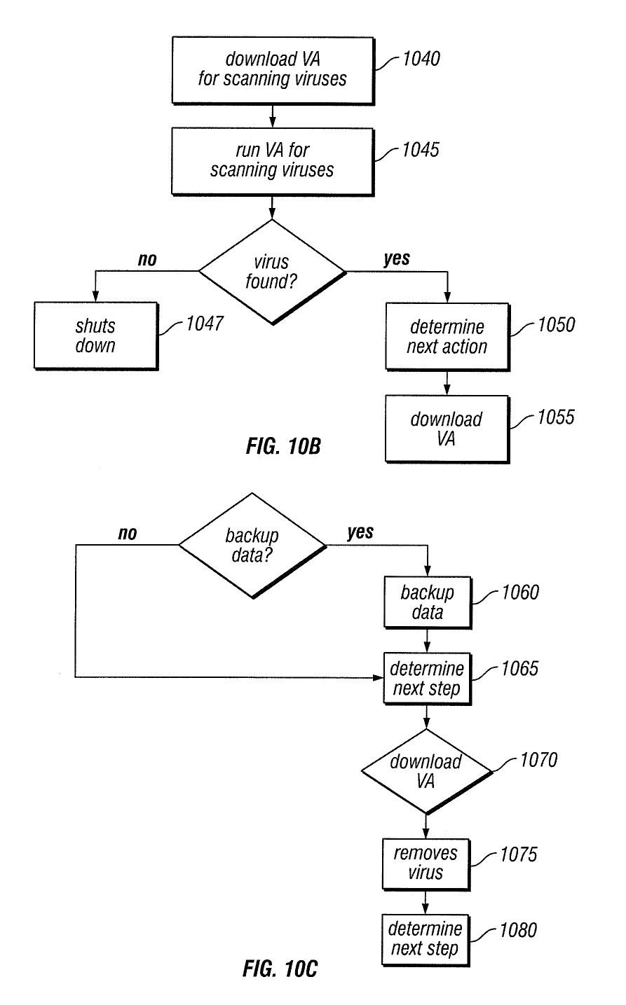

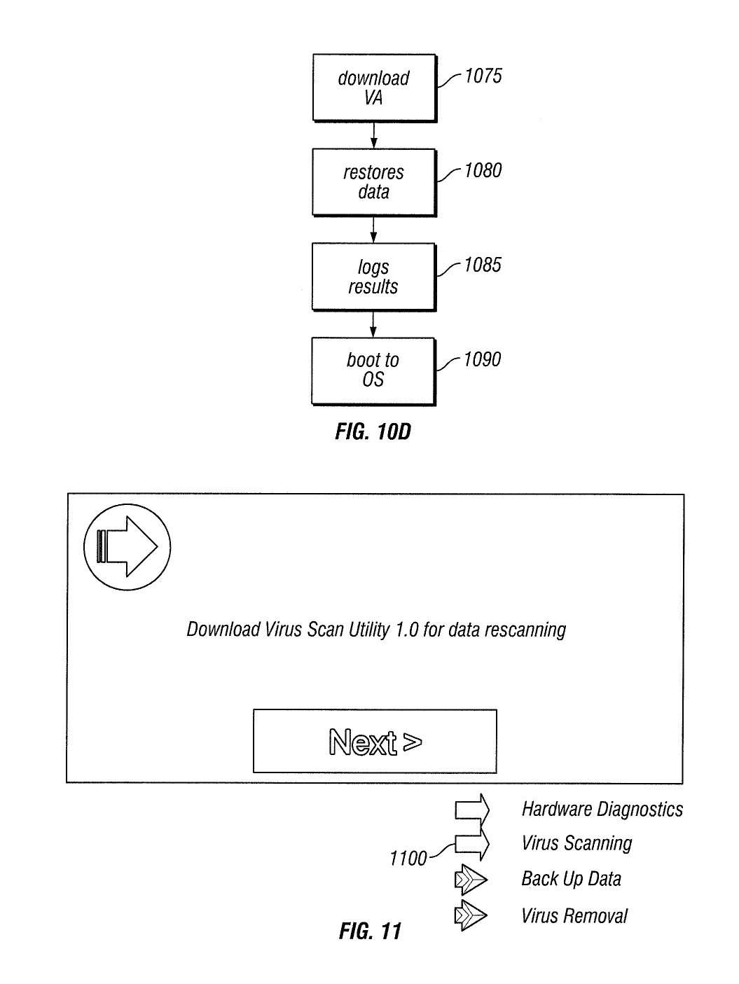

FIG. 10 is a flowchart that illustrates the steps of using a VA for scanning viruses according to one embodiment of the invention. When a user 100 suspects 1000 that the computer is experiencing a problem, the user 100 shuts 1005 down the computer and presses 1010 a “help” button. The button can be a hotkey located on a desktop computer or a laptop, examples of which will be apparent to one of ordinary skill in the relevant art. The VAE 110 displays a problem screen with several options for the type of problem that the user 100 is experiencing, e.g. Microsoft Windows does not boot, Application error, etc.

The VAE 110 launches 1015 and provides the user 100 with the option to select the download of a VA for diagnosing a hardware or software error. The VAE 110 sends 1020 an incident report to the server 120, which logs 1025 the incident. The VAE 110 runs 1030 the VA to determine whether the problem is due to a hardware or software error. If the VA does not find a hardware or software error error, the VAE 110 transmits the results to the server 120, which determines 1035 the next course of action.

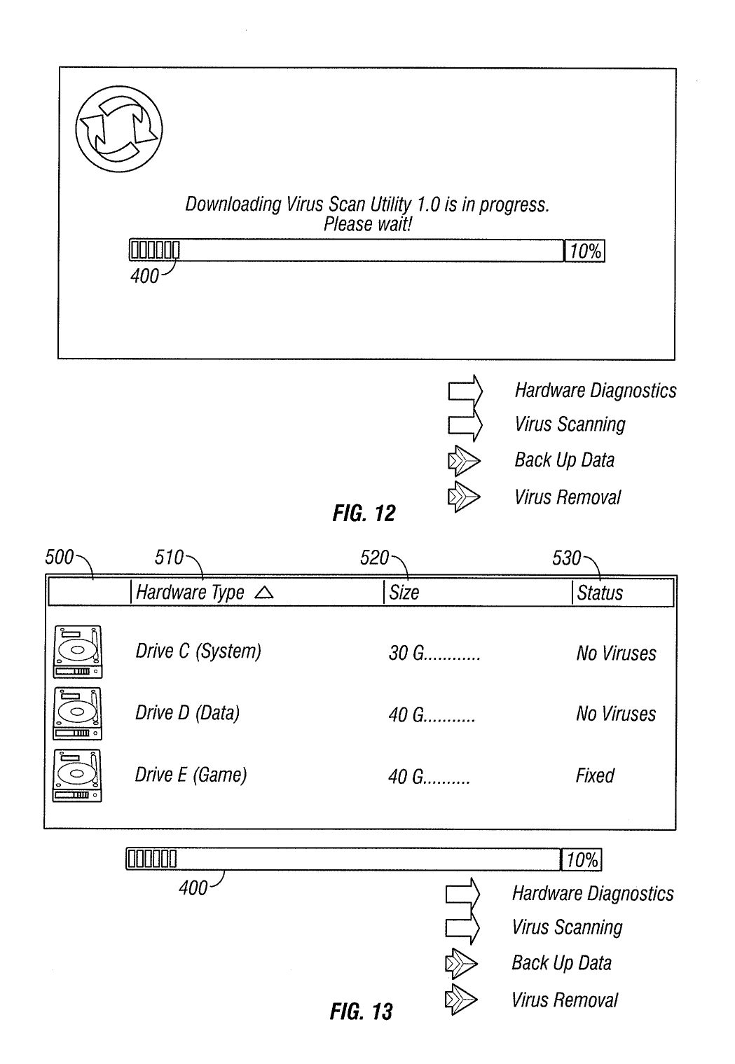

The server 120 instructs the VAE 110 to download 1040 a VA for scanning viruses. FIG. 11 is an example of the display screen that illustrates the option of selecting a virus scanning utility for download. While the VA downloads, the VAE 110 displays a screen to the user 100 that shows the progress of the download. The virus scanning stage arrow is dark-gray, indicating that the VAE 110 is in the virus scanning stage. FIG. 12 is an example of a display screen that illustrates the progress of a download for the virus scanning utility in the form of a progress bar 400.

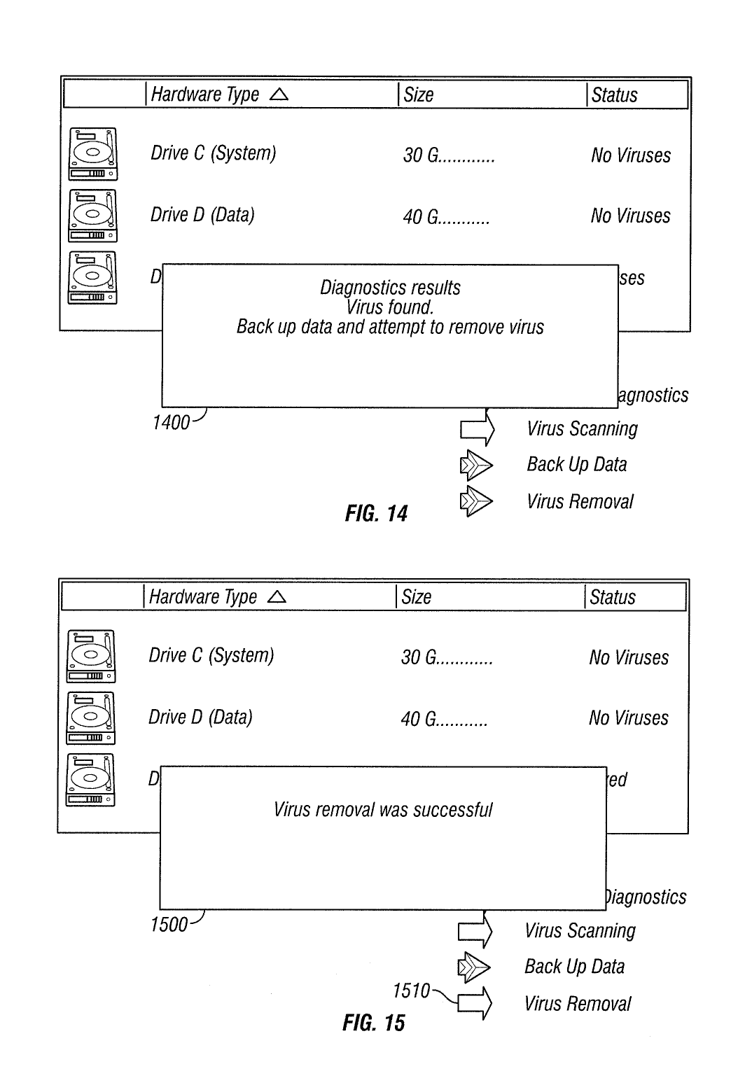

The VAE 110 runs 1045 the virus scanning VA. FIG. 13 is an example of a display screen that illustrates the progress of the virus scan. The screen includes a progress bar 400, icons 500 of the type of devices being tested, the hardware being scanned 510, e.g. Drive C, Drive D, Drive E, the size 520 of the hardware type, e.g. 30 G, and the status 530 of the test, e.g. no viruses, fixed. If a virus is not found, the VAE 110 shuts down 1047 the computer. In another embodiment, the VAE 110 downloads another scanning VA. If a virus is found, the server 120 determines 1050 the next course of action. FIG. 14 is an example of a display screen with a window 1400 laid over the display that indicates that a virus was found.

The server 120 determines 1050 that the next course of action is to backup data. The server 120 instructs the VAE 110 to download 1055 a VA for backing up data. The VAE 110 asks the user 100 whether the VA should perform a backup. If the user 100 wants to backup the data, the VA backs up 1060 data using either an online storage location or local storage.

Once the backup completes, or if the user 100 does not want to backup data, the server 120 determines 1065 the next step. The VAE 110 polls 120 the server 120, which transmits to the VAE 110 the name and other information for downloading 1070 a virus cleaner VA. The virus cleaner VA removes 1075 the virus. Examples of methods for removing, isolating, quarantining, and fixing viruses will be apparent to those of skill in the ordinary art. FIG. 15 is an example of a display that includes a window 1500 laid over the display that indicates that the virus removal was successful. The virus removal stage arrow 1510 is dark gray, indicating that the VAE 110 is in the virus removal stage.

Once the virus removal is successful, the server 120 determines 1070 the next step. If the user 100 previously backed up 1060 the data, the server 120 instructs the VAE 110 to download 1075 a VA for restoring the data. The VA for restoring data restores 1080 the previously backed up data to the computer, thereby avoiding a situation where data can become corrupted during the virus removal process. The server 120 logs 1085 the result of the virus removal. The user 100 boots 1090 to the default OS. Examples of operating systems include Microsoft Windows, Linux, etc. If the user 100 previously chose not to backup 1060 the data, the server 120 instructs the VAE 110 to download 1070 the virus cleaner and perform the same steps of removing the virus 1075 and booting 1090 to Microsoft Windows.

Onboard USB Flash

Some high-end motherboards include an onboard universal serial bus (USB) flash, which contains the embedded OS/real-time OS, the VAE, and VAs. Some of the capacity is still available. The extra space can be used for additional original equipment manufacturer (OEM) or diagnostic use, such as storing drivers for the main OS, the latest BIOS image and BIOS flash tool, or the full image of the support CD that normally comes with the system.

The diagnostic VAE can make use of this space to more quickly diagnose problems or even resolve the software problems. For instance, with the latest BIOS, the diagnostic VAE can re-flash the BIOS without having to wait for the download. With the main OS drivers, the diagnostic VAE, could discover a problem with a driver and assist with the re-installation.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A method for remotely diagnosing hardware and software errors on a client running a virtual appliance environment (VAE) stored on said client, the method comprising:
launching a virtual application (VA) stored on said VAE for diagnosing said hardware and software errors;
transmitting an incident report to a server;
testing said client for said hardware and software errors using said VA;
generating a result list based on said testing of said client;
transmitting said result list to said server, said server diagnosing said hardware and software errors using said result list;
downloading a VA for backing up data stored on said client; and
backing up said data using said VA.

2. The method of claim 1, wherein said VAE communicates with said server by polling said server.

3. The method of claim 1, wherein said VAE uses onboard universal serial bus flash stored on a motherboard of said client.

4. The method of claim 1, further comprising the step of determining whether said client is covered by a warranty if there is an error.

5. The method of claim 4, wherein said VAE accesses a database on a server to obtain to determine whether said client is covered by said warranty.

6. The method of claim 1, wherein said VAE runs on an embedded operating system.

7. A method for remotely locating a virus on a client running a virtual appliance environment (VAE) stored on said client, the method comprising:
launching a VAE;
downloading a virtual appliance (VA) for scanning viruses on said client;
running said VA for scanning viruses on said client;
generating a result list based on said scanning of said client;
transmitting said result list to said server, said server identifying said virus using said result list;
downloading a VA for cleaning viruses on said client; and
removing said virus with said VA for cleaning viruses.

8. The method of claim 7, further comprising:
downloading a backup tool for backing up data; and
backing up said data.

9. The method of claim 8, further comprising restoring said backed-up data after removing said virus.

10. The method of claim 7, further comprising:
generating a log of a result of removing said virus;
transmitting said result to said server.

11. The method of claim 7, further comprising booting a default operating system after said virus is removed from said client.

12. An apparatus for diagnosing a malfunction in a client comprising:
a virtual appliance environment (VAE) stored on a stored on a computer-readable medium comprising:
a virtual appliance (VA) for testing said hardware and software and generating a result list;
a VA for saving data residing on said client and generating a result list;
a VA for scanning said client for viruses; and
a first server that diagnoses said hardware and software errors and said viruses based on said result lists, said first server instructing said VAE to backup said data if at least one of an error and virus is found.

13. The apparatus of claim 12, further comprising a second server containing warranty information about said client;
wherein said first server determine whether said client is under warranty if an error is encountered by accessing said warranty information on said second server.

14. The apparatus of claim 12, wherein said virtual appliance generates a shipping address for said client if said client experiences at least one of a hardware and software error.

15. The apparatus of claim 12, further comprising a virus scanning utility for scanning said client, said virus scanning utility generating a result list based on said scanning of said client;

16. The apparatus of claim 15, wherein said VAE communicates with said first server by polling said first server.

17. The apparatus of claim 12, further comprising a virus cleaner for removing said virus.

18. The apparatus of claim 17, wherein said VAE restores said backed up data once said virus is removed.

19. The apparatus of claim 12, wherein said VAE uses an onboard universal serial bus flash stored on a motherboard of said client.

20. The apparatus of claim 12, wherein said VAE launches a VA.
